(19) United States
(12) Patent Application Publication
(10) Pub. No.: US 2008/0079552 A1
(43) Pub. Date: Apr. 3, 2008

(54) Harness system for auxiliary vehicle lights

(76) Inventor: Lynn W. Schultz, Kewaskum, WI (US)

Correspondence Address: BOYLE FREDRICKSON S.C., 840 North Plankinton Avenue, MILWAUKEE, WI, 53203, US

(21) Appl. No.: 11/652,197

(22) Filed: Jan. 11, 2007

Related U.S. Application Data
(60) Provisional application No. 60/827,293, filed on Sep. 28, 2006.

(51) Int. Cl. B60R 9/00

(52) U.S. Cl. 340/431

(57) ABSTRACT

A harness system is provided that allows for the connection of auxiliary lights disposed on an attachment for a motor vehicle, such as a snow plow, trailer, or the like, that enables the auxiliary lights to be quickly connected and disconnected from the electrical system of the vehicle. The connection made between the auxiliary lights and the vehicle electrical system utilizing the harness system disconnects the vehicle headlights and other signal lights such that power utilized to operate these vehicle lights is redirected to the auxiliary lights disposed on the attachment. The harness system includes an adapter harness connected between the electrical system of the vehicle and either the vehicle lights or the auxiliary lights is such that only one connection needs to be broken and reestablished in order to switch the power from the vehicle electrical system between the auxiliary lights from the vehicle lights, or vice versa.

### CROSS REFERENCE TO RELATED APPLICATION

This application claims priority under 35 U.S.C. §119(e) from U.S. Provisional Patent Application Ser. No. 60/827,293, filed on Sep. 28, 2006, the entirety of which is incorporated by reference herein.

### FIELD OF THE INVENTION

The present invention relates to attachments for vehicles, such as trailers and snowplows, among others, and more specifically to a wiring harness system for connecting auxiliary lights disposed on a vehicle attachment to the power system of the vehicle.

### BACKGROUND OF THE INVENTION

Many different types of devices and attachments are designed for use with existing vehicles, such as trailers and snow plows, among others, to enable the vehicles to perform functions in addition to transporting individuals and items from one location to another. These attachments are designed to be secured to either the front or rear of the vehicle, and often times obscure the headlights or taillights and turn signal lights located on the vehicle when attached to the vehicle. Therefore, in order to provide an operator of the vehicle with the ability to utilize the vehicle and the attachment in low light or during nighttime conditions, and to indicate the direction of the vehicle and attachment are traveling to other vehicles, it is necessary to include substitute or auxiliary lights on the attachment that is secured to the vehicle.

To control the operation of these lights from the interior of the vehicle, these auxiliary lights on the attachment must be operatively connected to the vehicle. To do so, a number of different types of operative connections have been developed which enable the connection of the auxiliary lights on the attachment to the electrical system of the vehicle such that the auxiliary lights can be powered and controlled by the operator of the vehicle.

However, while these systems enable the auxiliary lights on the attachment to be powered and controlled by the operator of the vehicle, the systems involve a number of complicated and cumbersome components that often must be integrated into the existing power system of the vehicle in order to allow for the auxiliary lights to be operated in conjunction with or entirely separately from the existing vehicle lights. In addition, those connection systems that can be added onto the existing electrical system within the vehicle also include multiple of components that each must be connected in a particular manner in order to enable the auxiliary lights to be operated in a correct manner.

As a result, it is desirable to develop a system for connecting auxiliary lights disposed on a vehicle attachment to the electrical system of a vehicle which includes a minimum of components and which can easily be utilized with existing vehicle electrical systems.

### SUMMARY OF THE INVENTION

According to a first aspect of the invention, a harness system is provided for connecting auxiliary lights on a vehicle attachment, such as a snow plow, trailer or the like, to the electrical system of a vehicle on which the attachment is mounted. The system includes an adapter harness that is connected directly to the electrical system of the vehicle between the electrical system and a headlight for the vehicle. The adapter harness is directly securable to the electrical system of the vehicle at the junction where the vehicle headlight would normally be connected to the power system. The adapter harness includes a first connector that is connectable to a second connector located on a vehicle light harness secured to the vehicle headlight. In this method of operation, the adapter harness functions as a part of the electrical system of the vehicle by supplying power from the electrical system of the vehicle through the adapter harness and the vehicle light harness to the vehicle headlight. The harness system also includes an auxiliary light harness that is connected to the auxiliary lights disposed on the attachment, and which includes a third connector engageable with the first connector on the adapter harness. Thus, when an attachment is secured to the vehicle including the harness system, in order to operate the auxiliary lights, the vehicle light harness secured to the vehicle headlights is simply disconnected from the adapter harness, which is subsequently reconnected to the auxiliary light harness. This quickly and effectively disables the headlights while enabling the auxiliary headlights to be operated using the controls for the vehicle headlights within the vehicle.

According to another aspect of the present invention, the adapter harness can be configured to be connected to the vehicle electrical system at one or both locations at which the vehicle headlights are connected to the electrical system such that either one or two adapter harnesses can be connected to the vehicle electrical system to supply power to either the vehicle lights or the auxiliary lights, further reducing the number of components of the harness system.

According the still another aspect of the present invention, the auxiliary light harness and/or the vehicle light harness can also be configured to be connected to one light or both lights on the attachment or the vehicle such that the respective auxiliary or vehicle headlights can be connected to the adapter harness and electrical system of the vehicle and the adapter harness either using a single connection or a pair of separate connections.

According to still a further aspect of the present invention, the various connectors on the adapter harness and the vehicle light harness or auxiliary light harness can be configured as desired both with regard to the number of electrical connections made between the connectors in order to operate various light configurations present on the vehicle or the attachment, including daytime running lights, if necessary. Further, the connectors on each of the pair of vehicle light or auxiliary light harnesses, if two harnesses are utilized, can be configured to allow each pair of harnesses to be connected to one another in sealing engagement to protect the connectors when not in use.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is a schematic view of a first embodiment of the harness system of the present invention;

FIG. 2 is a schematic view of the harness system of FIG. 1 illustrating the electrical connectors located on each of the adapter harness and auxiliary light harness of the harness system of FIG. 1;

FIG. 3 is a schematic view of a second embodiment of the harness system of FIG. 1;

FIG. 4 is a schematic view of a third embodiment of the harness system of FIG. 1;

FIG. 5 is a schematic view of a fourth embodiment of the harness system of FIG. 1;

FIG. 6 is a schematic view of a fifth embodiment of the harness system of FIG. 1;

FIG. 7 is a schematic view of a sixth embodiment of the harness system of FIG. 1;

FIG. 8 is a schematic view of a seventh embodiment of the harness system of FIG. 1;

FIG. 9 is a schematic view of an eighth embodiment of the harness system of FIG. 1;

FIG. 10 is a schematic view of a ninth embodiment of the harness system of FIG. 1;

FIG. 11 is an schematic view of a tenth embodiment of the harness system of FIG. 1; and

FIG. 12 is a schematic view of an eleventh embodiment of the harness system of FIG. 1.

### DETAILED DESCRIPTION OF THE INVENTION

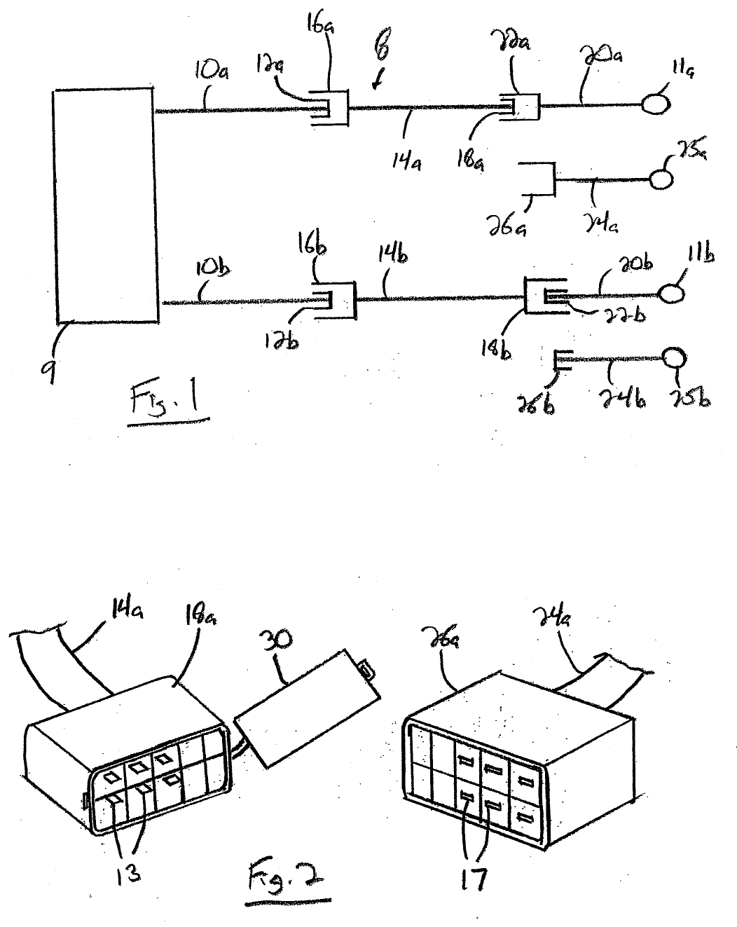

With regard to the drawing figures in which like reference numerals designate like parts throughout the disclosure, a first embodiment of the harness system is indicated generally at 8 in FIGS. 1-3. Generally, the harness system 8 includes a left vehicle power harness 10a and a right vehicle power harness 10b that are connected to the power system or supply 9 within the vehicle (not shown) for the left and right vehicle lights 11a and 11b, respectively. Power harnesses 10a and 10b can be integrally formed with the vehicle power system, or can be formed as parts of the system 8, and each include respective adapter connectors 12a and 12b, which may be male connectors or female connectors. Each first connector 12a and 12b has a number of pins 13 that direct power to and from the power harnesses 10a and 10b and the associated lights 11a and 11b. The particular number of pins 13 in the connectors 12a and 12b can be varied depending upon the number of lights on the vehicle in addition to the lights 11a and 11b, such as daytime running lights and/or work lights (not shown). Also, the first connectors 12a and 12b, in instead of being formed of a single connector, can be formed with separate connector portions (not shown) that together form the connectors 12a and 12b and can each be connected to a corresponding part of the power supply of the vehicle.

The system 8 also include a pair of adapter harnesses 14a and 14b that are configured for interconnection with left and right vehicle power harnesses 10a and 10b, respectively. Adapter harnesses 14a and 14b include respective first connectors 16a and 16b, which can be male or female and include a number of sockets 17 that are configured for engagement with the pins 13 located in the respective adapter connectors 12a and 12b on the left and right vehicle power harnesses 10a and 10b, or vice versa. At the opposite end, in one embodiment, the adapter harnesses 14a and 14b each includes a light connector 18a and 18b, each with the same pin or complementary slot configuration as the corresponding first connector 16a or 16b on the respective harness 14a or 14b. The connectors 18c and 18b can be formed separately or integrally, or each formed into separate connectors (not shown) to attach to varying lights on the attachment, such as low beam, high beam, headlight common, daytime running lights, turn lights, and work lights, among other types.

The system 8 further includes a vehicle light adapter harness 20a connected to the primary left vehicle light 11a, and includes a second connector 22a that is configured to be engageable with the light connector 18a of adapter harness 14a. Similarly, a second vehicle light adapter harness 20b is connected to the right vehicle light 11b, and includes a second connector 22b that is configured to be engageable with the light connector 18b at the end of adapter harness 14b.

With regard to the particular attachment (not shown) that is to be secured to the vehicle, such as a snow plow, trailer, or the like, the system 8 also includes a left auxiliary light harness 24a that is connected to a left auxiliary light 25a disposed on the attachment at one end, and includes a third connector 26a at its opposite end that is configured to be securable to the light connector 18a on the adapter harness 14a. The system 8 also includes a right auxiliary light harness 24b that is connected to a right auxiliary light 25b disposed on the attachment at one end, and includes a third connector 26b at its opposite end that is configured to be securable to the light connector 18b on the adapter harness 14b.

The first connectors 16a and 16b and light connectors 18a and 18b on the adapter harnesses 14a and 14b, the second connectors 22a and 22b on the light adapter harnesses 20a and 20b, and the third connectors 26a and 26b on the auxiliary light harnesses 24a and 24b may have as many sockets 17 or pins 13 as are needed to conform to those on the adapter connectors 12a and 12b and to supply power to all of the various lights with which the vehicle is equipped. The various connectors 16a, 16b, 22a, 22b, 26a and 26b may have as few as six (6) pins or as many as twelve (12) pins in order to handle vehicles with daytime running lights or work lights. Various versions of the harness system 8 may be employed to accommodate the presence or absence of daytime running lights on a vehicle. The connections between the adapter harnesses 14a and 14b and either the light adapter harnesses 20a and 20b or the auxiliary light harnesses 24c and 24b are preferably made near to, and most preferably, outside of the bumper of the vehicle.

In one version of the system 8, where the vehicle does not include a system for monitoring amperage changes in the turn and marker light circuits, the auxiliary turn and marker light circuits (not shown) are spliced into the vehicle turn and marker light circuits (not shown). This system allows the vehicle turn and marker lights to function when the auxiliary lights are attached to the vehicle. In this embodiment, the vehicle light harnesses 20a and 20b have three wires for high beam, low beam and common of the headlights 11a and 11b. When the turn or marker light is operated, both the vehicle lights 11a and 11b and auxiliary lights 25a and 25b operate. If daytime running lights are present, this system 8 uses either the high beam or low beam circuit to operate the daytime running lights. The function of the daytime running lights is transferred to the auxiliary lights when connected. Additionally, wiring for attachment controls, i.e., snow plow controls, and/or additional motors can be incorporated into the system 8.

In a second version of the system 8, all of the lights including the turn and marker lights of the vehicle front lights are disengaged, e.g. when a snowplow is attached. The vehicle light adapter harnesses 20a and 20b again have six wires including high beam, low beam and common of the headlight and the turn, marker and common as well. With this system, only the auxiliary lights 25a and 25b function when the plow is attached. When the vehicle light adapter harnesses 20a and 20b are attached, then all the front lights operate as original equipment. In a system such as this, the daytime running lights use one of the lamps (e.g. the high beam, low beam, turn or marker lamps) on the vehicle so that, when a snowplow is attached, the daytime running lights are transferred to the corresponding plow lamp.

In a third version of the system 8, an additional two wires are added to the six wires on the connectors 20a and 20b as set forth above for independent daytime running lights. Because of additional daytime running lights on the vehicle, the auxiliary lights can have two additional lights to be mounted to the snowplow attachment so that daytime running lights then function on the attachment, i.e., the snowplow. If no additional lights are added to the attachments, the lights on the attachment, as a result of a connection to a separate module (not shown) and the plow low beam circuit to reduce the power supplied in the circuit for the lights to be operated as daytime running lights.

In the first embodiment of the system 8, the light connector 18a of left adapter harness 14a is configured as a male connector and will only plug into either the second connector 22a on the left vehicle light adapter harness 20a or the third connector 26a left auxiliary light harness 24a, which are each configured as female connectors. Similarly, the light connector 18b of right adapter harness 14b is configured as a female connector and will only plug into either the second connector 22b on the right vehicle light adapter harness 20b, or the third connector 26b on the right auxiliary light harness 24b, which are each configured as male connectors. This configuration for the system 8 provides simple and foolproof attachment of either the vehicle lights 11a and 11b or the auxiliary lights 25a and 25b to the adapter harnesses 14a and 14b for proper operation of the system 8. In addition, when the auxiliary lights 25a and 25b are not in use and the vehicle light adapter harnesses 20a and 20b are connected to the respective adapter harnesses 14a and 14b, the female connector 26a and the male connector 26b of respective left and right auxiliary light harnesses 24a and 24b are connected together in a sealed manner in order to prevent corrosion when the connectors are plugged together and to prevent harnesses 24a and 24b from dangling within the engine compartment of the vehicle. Similarly, when the third connectors 26a and 26b on the auxiliary light harnesses 24a and 24b are connected to respective light connectors 18a and 18b of adapter harnesses 14a and 14b, the vehicle light connectors 22a and 22b are connected together. Again, this prevents corrosion of the connector components and also prevents the harnesses 20a and 20b from dangling in the engine compartment.

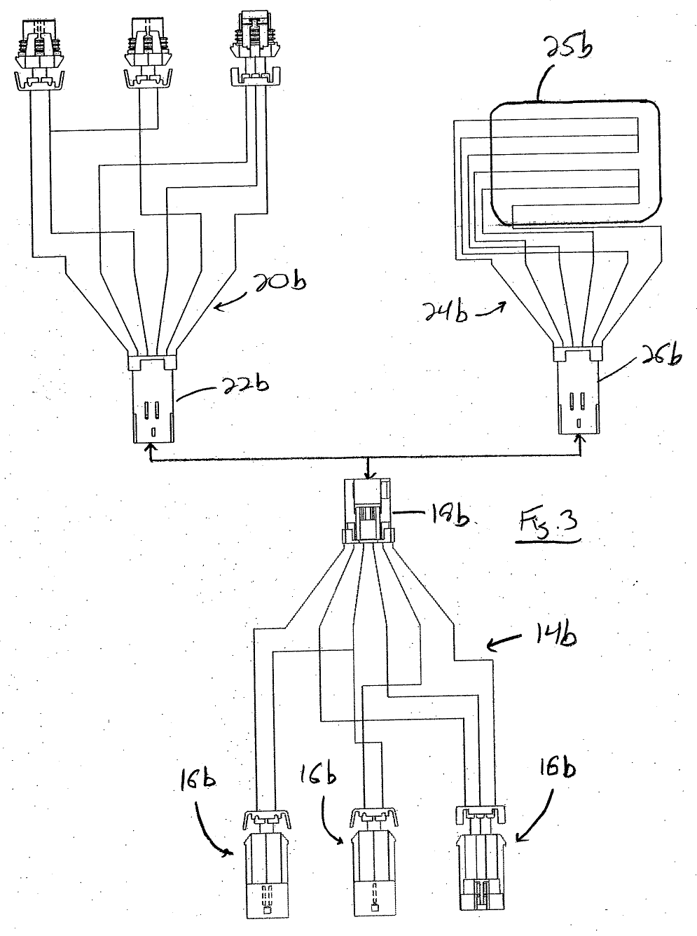

As an alternative to the various connectors 22a and 22b, and 26a and 26b being engageable with one another when not in use, sealing caps 30 (FIG. 2) can be disposed on the respective connectors 22a, 22b, 26a and 26b that are engaged with the exposed ends of each connector 22a, 22b, 26a and 26b to cover the exposed connection components and protect against corrosion.

The harness system 8 including the adapter harnesses 14a and 14b, the vehicle light harnesses 20a and 20b, and the auxiliary light harnesses 24a and 24b, and the associated connectors, eliminates the need for a main harness, as is required with prior art systems, and enables the operator to operate the auxiliary lights 25a and 25b using the same on/off switch as is used for the primary vehicle lights 11a and 11b. The same switches for the other vehicle lights, e.g., turn lights, worker lights, etc. also can be used to operate the corresponding lights on the attachment.

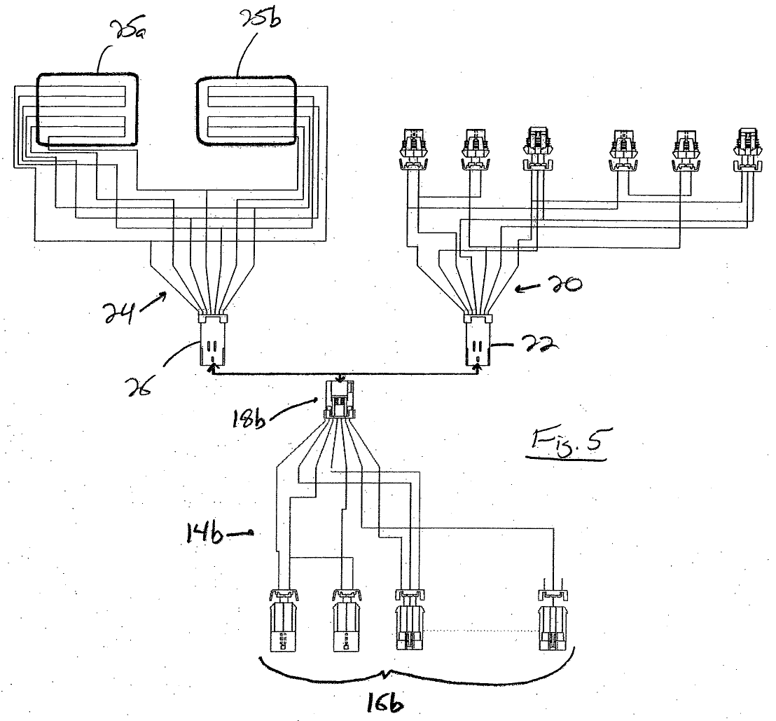

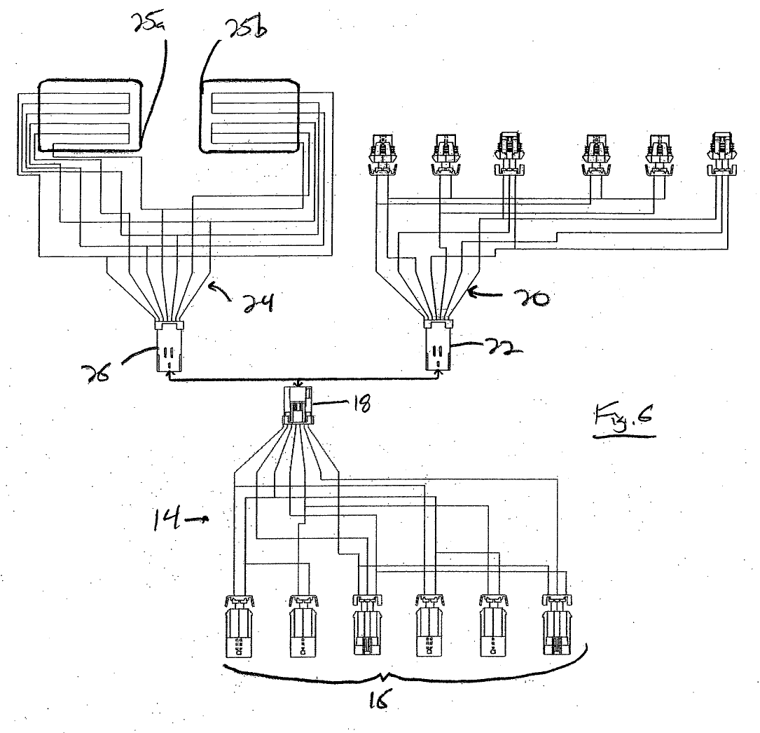

In other embodiments of the system 8, as best shown in FIGS. 4 and 5, the connectors 22a and 22b for the vehicle light harnesses 20a and 20b, and the connectors 26a and 26b for the auxiliary light harnesses 24a and 24b can each be combined into one connector 22 and 26, respectively, on a single vehicle light harness 20 and a single auxiliary light harness 24. These individual connectors 22 and 26 can be connected to one of the light connectors 18a or 18b on one adapter harness 16a or 16b to power both vehicle lights 11a and 11b, or both auxiliary lights 25a and 25b from one side of the vehicle. The various connectors 18a, 18b, 22 and 26 can also be configured with the necessary number of pins 13 and sockets 17 to accommodate the particular circuits present in the vehicle power system.

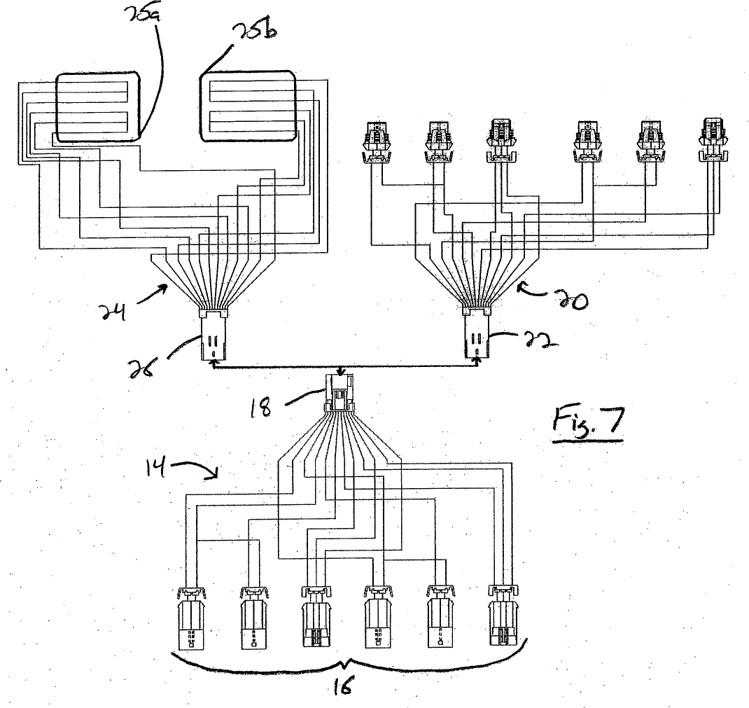

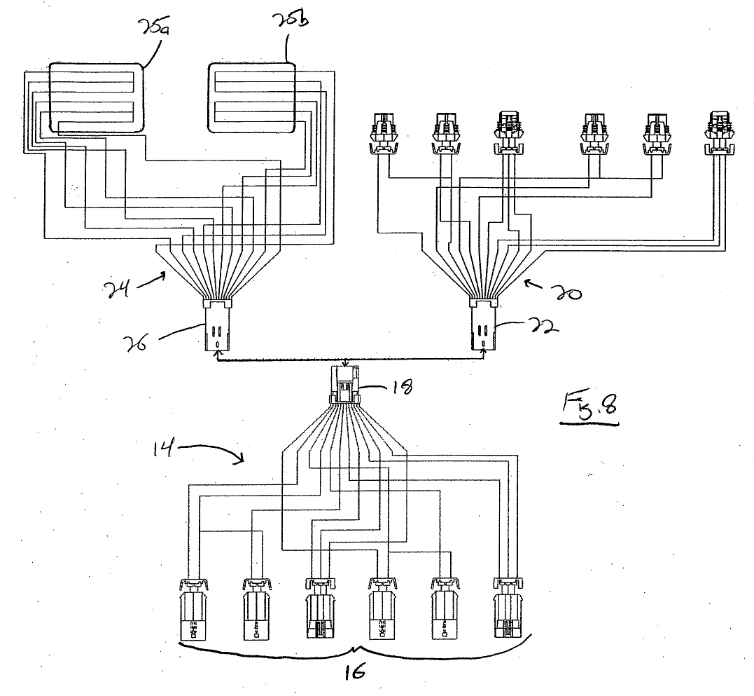

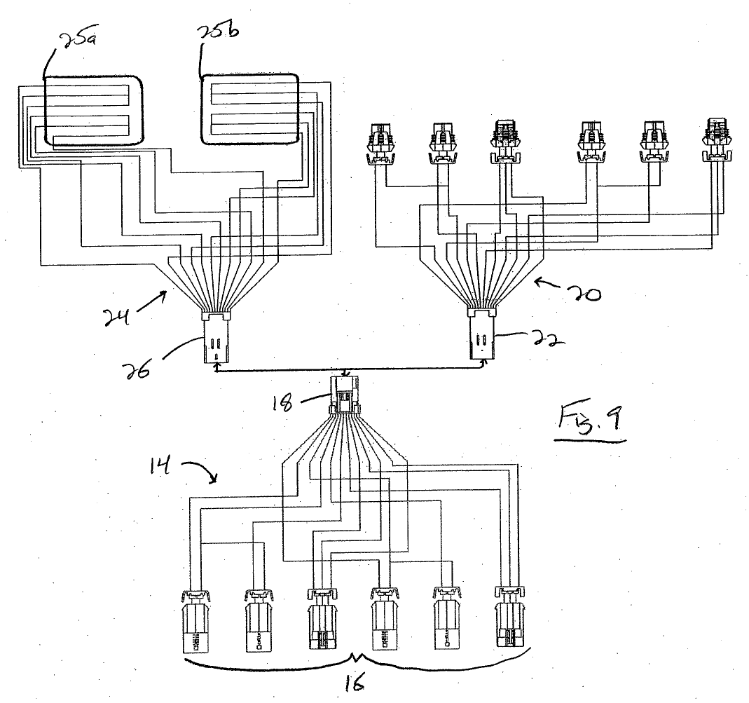

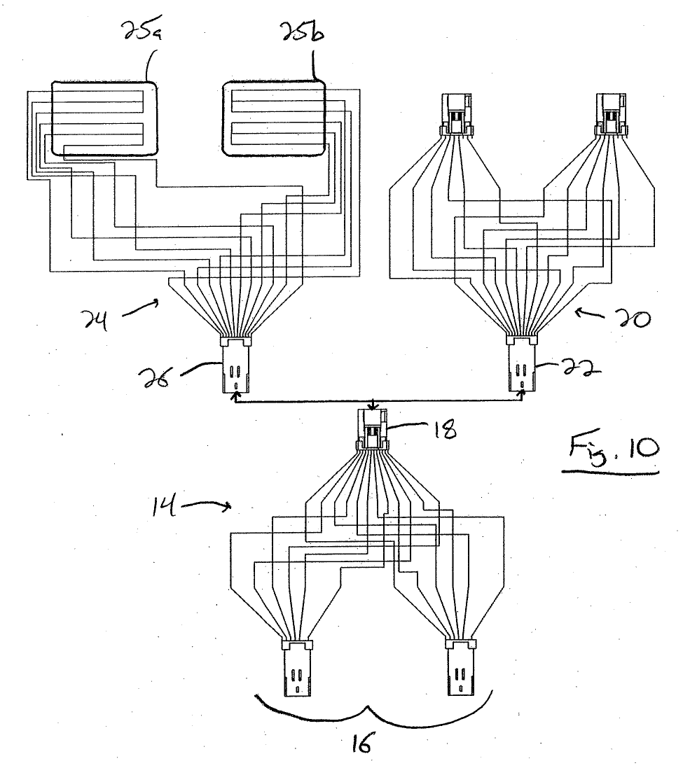

Alternatively, referring now to FIGS. 6-9, the adapter harnesses 14a and 14b can be combined similarly to the vehicle light harnesses 20a and 20b and the auxiliary light harnesses 24a and 24b described previously to form a single adapter harness 16 with a single light connector 18 which can be utilized with the united vehicle light harness 20 and auxiliary light harness 24. Further, as illustrated by the different circuits shown in the embodiments for the system 8 in FIGS. 6-9, the various connectors 18a, 18b, 22 and 26 can also be configured with the necessary number of pins 13 and sockets 17 to accommodate the particular circuits present in the vehicle power system.

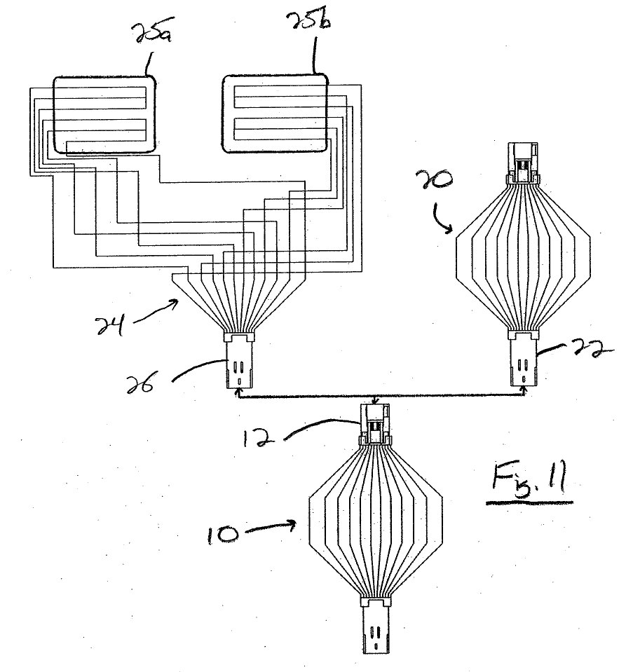

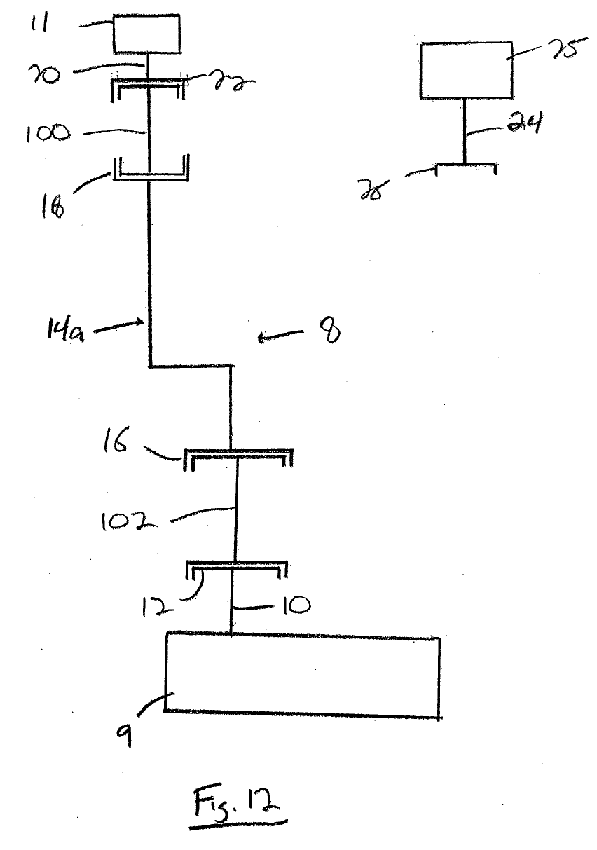

Looking now at FIGS. 10 and 11, in still further embodiments of the system 8, the vehicle power harnesses 10a and 10b are omitted, such that the adapter harnesses 14a and 14b are connected directly to the vehicle power system at a point prior to the vehicle power system splitting towards the left and right side of the vehicle. In this embodiment, the adapter harnesses 14a and 14b of the previous embodiment are combined into a single harness 14 having a single first connector 16 engaged with the power system for the vehicle, and one or two light connectors 18a, 18b at the opposite end of the harness 14. In FIG. 10, where two light connectors 18a and 18b are utilized, two vehicle light harnesses 20a and 20b, with associated second connectors 22a and 22b, and two auxiliary light harnesses 24a and 24b, with associated third connectors 26a and 26b, are utilized to connect the vehicle lights 11a and 11b or the auxiliary lights 25a and 25b to the power system. Alternatively, as shown in FIG. 11, a single light connector 18 can be present in the adapter harness 14, such that only a single vehicle light harness 20 and second connector 22, and a single auxiliary light harness 24 and connector 26 are employed in the system 8. In these embodiments of the system 8, instead of omitting the power harnesses 10a and 10b, the adapter harness 14a and 14b can be omitted, such that the power harness 10, or harnesses 10a and 10b, in whatever configuration are connected directly between the vehicle power system and one of the vehicle light harness 20 or harnesses 20a and 20b, or the auxiliary light harness 24 or harnesses 24a and 24b.

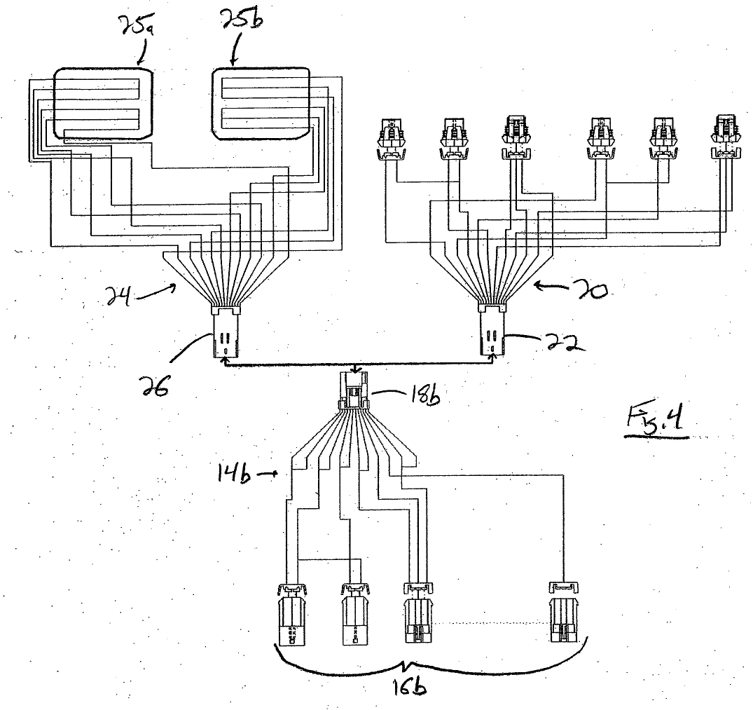

Still another embodiment for the harness 8 similar to FIG. 3, FIG. 12 shows the harness 8 including an adapter harness 14 that is used with all types of vehicles, and a pair of specific light connectors 100 and 102 connected to opposite ends of the harness 14. The connectors or harnesses 100 and 102 are each configured to be utilized with a specific vehicle, with connector 100 connected between the adapter harness 14 and the vehicle light 11 or the auxiliary light 25, and the connector 102 connected between the adapter harness 14 and the vehicle power harness 10. By employing the connectors 100 and 102 with the adapter harness 14, kits forming the harness 8 for use with different types of vehicles 9 can be created with the adapter harnesses 14 and the required connectors 100 and 102 for the specific vehicle. In addition, the harness 8 shown in FIG. 12 can be modified to have any of a number of configurations, such as those shown in prior FIGS. 1-11.

The system 8 of the present invention has a number of advantages over existing systems that supply power to auxiliary lights in vehicles. Such advantages include, but are not limited to, the following:
1. The system 8 does not require any switches, relays or electronics to switch the primary vehicle lights to the auxiliary lights. All that is required is to connect the power harness(es) and/or adapter harness(es) to the vehicle power supply, and to then engage the appropriate one of the connectors of either the light harness(es) for the primary vehicle lights or the auxiliary lights with the adapter harness in order to provide power to the appropriate set of lights.
2. The system 8 does not require the installation of a main harness, which also can cause problems in troubleshooting or can cause shorts in the system. This substantially reduces cost by eliminating the amount of wire required to build the main harness, and also eliminates the connectors, pins and seals associated with a main harness.
3. The system 8 in a preferred embodiment requires only six wires at minimum in order to control the high beam, low beam, turn signal, marker lights and common for the vehicle lights and the auxiliary lights. If running lights are used, only two additional wires are required for each adapter harness. On the other hand, if the daytime running lights operate off either the high, low, turn signal or marker lamps, then only six wires are required for each side.
4. The system 8 guards against corrosion by using sealed connectors.
5. The system 8 is easy to troubleshoot simply by making selective connections to identify the source of a problem.
6. The system 8 is easy to install, in that all connections are simple male/female connections.
7. The system 8 is very cost effective in manufacture, assembly and installation.
8. The system 8 utilizes a small number of parts to be stocked both at the manufacturing level and at the dealer level.

Additionally, it is to be understood that, where a certain connector has been illustrated or described as a male connector that is engageable with a female connector, a reverse arrangement could also be employed such that a female connector is engageable with a male connector.

Various alternatives are contemplated as being within the scope of the following claims, particularly pointing out and distinctly claiming the subject matter regarded as the invention.

I claim:

1. An auxiliary light harness system for a vehicle, comprising:
at least one adapter harness configured to be connected to a vehicle power supply;
at least one vehicle light harness connectable to a vehicle light and to the at least one adapter harness to operate the vehicle light; and
at least one auxiliary light harness connectable to an auxiliary light and to the at least one adapter harness in place of the at least one vehicle light harness to operate the auxiliary light.

2. The system of claim 1 wherein the at least one adapter harness includes a first connector and the at least one vehicle light harness includes a second connector securable to the first connector.

3. The system of claim 2 wherein the first connector is selected from the group consisting of a male connector and a female connector, and the second connector is formed to be complementary to the first connector.

4. The system of claim 3 wherein the second connector is formed with one of a plurality of pins or sockets securable to the corresponding sockets or pins on the first connector.

5. The system of claim 4 wherein the second connector is formed with a number of pins.

6. The system of claim 5 wherein the second connector has a variable number of pins.

7. The system of claim 2 further comprising a sealing cap disposed on the at least one vehicle light harness and engageable with the second connector.

8. The system of claim 2 wherein the at least one auxiliary light harness includes a third connector connectable to the first connector in place of the second connector.

9. The system of claim 8 wherein the first connector is selected from the group consisting of a male connector and a female connector, and the third connector is formed to be complementary to the first connector.

10. The system of claim 9 wherein the third connector is formed with one of a plurality of pins or sockets securable to corresponding sockets or pins on the first connector.

11. The system of claim 10 wherein the third connector is formed with a number of pins.

12. The system of claim 11 wherein the third connector has a variable number of pins.

13. The system of claim 8 further comprising a sealing cap disposed on the at least one auxiliary light harness and engageable with the third connector.

14. The system of claim 1 further comprising at least one power harness connected to the vehicle power supply at one end and to the adapter harness at the opposite end.

15. The system of claim 1, including a pair of adapter harnesses each connected to the vehicle power supply and having a first connector disposed opposite the vehicle power supply, a pair of vehicle light harnesses each connected to a vehicle light and having a second connector disposed opposite the vehicle light, and a pair of auxiliary light harnesses each connected to an auxiliary light and having a third connector disposed opposite the auxiliary light.

16. The system of claim 15 wherein the first connectors are oppositely configured and wherein the second connectors are engageable together when the third connectors are engaged with the first connectors, and wherein the third connectors are engageable together when the second connectors are engaged with the first connectors.

17. A method of supplying power from a vehicle to a set of auxiliary vehicle lights, the method comprising the steps of:
securing at least one adapter harness having a first connector to a vehicle power supply opposite the first connector;
providing at least one vehicle light harness having a second connector and operably connected to at least one vehicle light opposite the second connector;
providing at least one auxiliary light harness having a third connector and operably connected to at least one auxiliary light opposite the third connector; and
interchangeably connecting either the second connector or the third connector with the first connector to supply power to either the at least one vehicle light or the at least one auxiliary light.

18. The method of claim 17 wherein a pair of vehicle light harnesses are provided with oppositely configured second connectors, and further comprising the step of interconnecting the second connectors with one another when the third connector is connected to the first connector.

19. The method of claim 17 wherein a pair of auxiliary light harnesses are provided with oppositely configured third connectors, and further comprising the step of interconnecting the third connectors with one another when the second connector is connected to the first connector.
